(19) United States
(12) Patent Application Publication
(10) Pub. No.: US 2026/0117548 A1
(43) Pub. Date: Apr. 30, 2026

(54) ROOF TENT AND A KIT OF PARTS

(71) Applicant: Tentbox Limited, Southampton (GB)

(72) Inventor: Oliver SHURVILLE, Southampton (GB)

(73) Assignee: Tentbox Limited, Southampton (GB)

(21) Appl. No.: 19/431,710

(22) Filed: Dec. 23, 2025

Related U.S. Application Data
(63) Continuation of application No. PCT/EP2024/060032, filed on Apr. 12, 2024.

(30) Foreign Application Priority Data
Jul. 13, 2023 (GB) 2310744.4

(51) Int. Cl. E04H 15/06; B60R 3/00; E04H 15/32; E04H 15/48; E04H 15/54; E04H 15/64

(52) U.S. Cl. CPC E04H 15/06; B60R 3/005; B60R 3/007; E04H 15/322; E04H 15/48; E04H 15/54; E04H 15/64

(57) ABSTRACT

A roof tent that includes a frame assembly and a mounting means for mounting the roof tent on a roof of a vehicle. The frame assembly is formed by a plurality of frame members that are reversibly attached such that the frame assembly is reversibly assembled. The frame assembly includes a base frame attached to the mounting means and a top frame attached to the base frame. The base frame assembly is formed by a plurality of frame members that are reversibly attached such that the base frame assembly is reversibly assembled and the top frame is formed by a plurality of frame members that are reversibly attached such that the top frame is reversibly assembled. The base frame is attached to the top frame by a fastening means. The fastening means are selected to be one of a hinge or clip.

### CROSS REFERENCE TO RELATED APPLICATIONS

This continuation application claims priority benefit from International Application No. PCT/EP2024/060032 filed on Apr. 12, 2024, which claimed priority from Great Britain Application No. 2310744.4 on filed Jul. 13, 2023, which are both incorporated herein by reference in their entirety.

### FIELD OF THE INVENTION

The present invention relates to a roof tent (e.g. for attachment to a roof of a vehicle) and a kit of parts for (e.g. assembling) a roof tent.

### BACKGROUND OF THE INVENTION

Roof tents are camping tents that, in use, are attached to the roofs of vehicles such as cars and vans. As such, a roof tent is a vehicle accessory. To go camping, the user merely needs to drive to an appropriate location and set-up the tent on the roof of their vehicle. Typically, the roof tent is attached to cross bars on the vehicle's roof and is transported while attached to the roof of the vehicle. The roof tent is generally detachably, reversibly or removably attached to the cross bars such that the user can detach roof tent when not in use.

Generally, when a vehicle is moving, a roof tent attached to the roof of the vehicle is provided in a packed, collapsed, stowed or flattened configuration, and may sometimes be covered or held inside a box or case. The roof tent is then set-up, erected, opened or put-up by the user at their desired camping location. Roof tents provide a quick, safe and convenient way for a user to go camping. Additionally, it is common for roof tents to be purchased by users inside the box or case within which it can be transported on the roof of a vehicle. Whilst these boxes and cases are compact in terms of transporting the tent, they are relatively bulky in terms of storing the product before purchase, in stores and warehouses or by the user at home, for example. Moreover, roof tents are typically very heavy and/or bulky items which are usually sold to a user in a pre-assembled form by virtue of the complex assembly requirements. As such, after purchasing the roof tent, the user is only required to attach the roof tent to the roof of a vehicle in order to use the tent. However, because of the size and weight of such roof tents, attaching the roof tent may be difficult, especially for a single person.

To improve their camping experience, users may wish to attach accessories to the roof tent. Examples of such accessories include ladders for accessing the roof tent, buckles or ropes for closing the roof tent, roof bars, cargo racks, awnings, coverings, sun showers, solar panels and the like. However, attaching accessories to the roof tent can be difficult for the user to do as the weight of the accessory may place undue strain on part of the roof tent and/or result in tearing or ripping of the tent canopy.

Objects and aspects of the present invention seek to alleviate at least these problems of the prior art.

### SUMMARY OF THE INVENTION

According to a first aspect of the invention, a roof tent is provided. Optionally, the roof tent comprising a mounting means for mounting the roof tent on a roof of a vehicle. Optionally, the roof tent comprising a frame assembly attached to the mounting means. Optionally, the frame assembly is formed by a plurality of (e.g. base, e.g. top) frame members that are reversibly attached such that the frame assembly is reversibly assembled.

According to a second aspect of the invention, a roof tent is provided, the roof tent comprising:
a mounting means for mounting the roof tent on a roof of a vehicle;
   a frame assembly attached to the mounting means, wherein the frame assembly is formed by a plurality of frame members that are reversibly attached such that the frame assembly is reversibly assembled.

The first and second aspects of the invention therefore provides an improved roof tent arrangement compared to those known in the art. In particular, the roof tent of the first and second aspects provide a means by which a roof tent may be assembled by a user at the point of use. Furthermore, the assembly may be easily disassembled meaning that the roof tent can be easily transported (e.g. by the manufacturer to a retailer or by the user upon purchasing the tent) as well as being compactly stored when not attached to a vehicles roof.

The following features and embodiments thus apply to both the first aspect and the second aspect equally.

In some embodiments, the frame assembly comprises a base frame attached to the mounting means. In some embodiments, the base frame is formed by a plurality of (e.g. base) frame members. Optionally, the plurality of (e.g. base) frame members are connected together reversibly such that the base frame is reversibly assembled. In some embodiments, the top frame is formed by a plurality of (e.g. top) frame members. Optionally, the plurality of (e.g. top) frame members are connected together reversibly such that the base frame is reversibly assembled. Preferably, each of the base frame and the top frame are formed by a plurality of frame members. Optionally, the plurality of frame members are connected together reversibly such that the frame assembly (i.e. the base frame and the top frame) is reversibly assembled. By using (base and/or top) frame members that can be connected together reversibly, the roof tent may be provided as a flat pack assembly which can be easily assembly by the user at the point of use, as well as being easily transported and stored by a user when the roof tent is not in installed on the roof of a car. This further provides economic benefits as the roof tent can be distributed and/or sold in a compact or disassembled form due to the simplified design and reduction in the complexity of assembly.

In some embodiments, the frame members are tubular members having a connection means at each end to allow the frame members to be connected together. Optionally, the connection means provides an interference fit or a transition fit between two of the plurality of frame members. In other words, two frame members are connected together by frictional engagement between the two members by receiving one end of a frame member inside an end of another frame member. In such arrangements, the frame members can be disconnected by applying a force significant enough to overcome the frictional forces (i.e. by pulling the frame members apart).

In some embodiments, the connection means may be a spring biased pin proximate to at least one of the ends of at least one the frame members. In some embodiments, at least one of the plurality of frame members comprises an aperture configured to receive the spring biased pin of another frame member. For example, the aperture may be located proximate to an end of the frame member. In some embodiments, the spring biased pin of a first frame member is received within an aperture of a second frame member when an end of the first frame member (comprising the spring biased pin) is inserted into an end (comprising the aperture) of the second frame member. The spring biased pin then locks the two frame members in place by virtue of the pin extending through the aperture. To disassemble the two frame members, the spring biased pin may be pressed such that the pin no longer extends through the aperture and the two frame members may be pushed apart. This provides a more secure attachment between the frame members of the frame assembly.

In some embodiments, the connection means may be a nut and bolt arranged proximate to at least one of the ends of at least one the frame members. In some embodiments, at least one of the plurality of frame members comprises an aperture configured to receive a bolt extending through one of the frame members. In some embodiments, both frame members that are being connected together may comprise apertures through which a bolt may extend to secure the two frame members together. For example, the aperture(s) may be located proximate to an end of the frame member(s).

Optionally, the connection means may be the same for all frame members in the frame assembly. For example, the (e.g. top, e.g. base) frame members may include spring pins to facilitate the connection of the (e.g. top, e.g. base) frame. Alternatively, different parts (e.g. the base frame, e.g. the top frame) of the frame assembly may have frame members with different connection means. For example, the top frame may be held together by spring pins included in the top frame members whilst the bottom frame may be held together by nuts and bolts included in the base frame members.

Optionally, the tubular members comprise a tubular body and at least two (e.g. two, e.g. three) ends, wherein the tubular body has a first diameter. Optionally, at least one (e.g. one, e.g. two, e.g. both, e.g. all) of the at least two ends has a diameter substantially equal to the first diameter. In other words, the tubular body having the first diameter extends continuously to at least one of the (at least two) ends. In some embodiments, at least one frame member of the plurality of frame members has one end having the first diameter. In some embodiments, at least one frame member of the plurality of frame members has all (e.g. both) of its ends having the first diameter.

Optionally, at least one (e.g. one, e.g. two, e.g. both, e.g. all) of the at least two ends has a second diameter, wherein the second diameter is different to (e.g. less than, e.g. greater than) the first diameter. For example, by providing a frame member with (at least) one end having a second diameter, the end having the second diameter can be inserted within an end having the first diameter when the second diameter is less than the first diameter. Alternatively, if the second diameter is greater than the first diameter, the end having the first diameter can be inserted within an end having the second diameter. Preferably, the second diameter is less than the first diameter. Preferably, the second diameter and the first diameter are sized such that an end (of a tubular member) having a second diameter forms an interference, transition or friction fit with an end (of another tubular frame member) having a first diameter. Within the meaning of the present invention, a tubular frame member is defined as a hollow elongate member which may have any suitable and/or desirable cross-section. For example, the tubular frame member may be cylindrical (thus having a circular cross-section). Alternatively, the tubular frame member may have a regular polygon or irregular polygon cross-section shape. For example, the cross-section shape may be a square, rectangle, (regular or irregular) hexagon, (regular or irregular) pentagon, (regular or irregular) heptagon, (regular or irregular) octagon, and so on.

In some embodiments, at least one (e.g. base, e.g. top) frame member of the plurality of (e.g. base, e.g. top) frame members has one end having the second diameter. In some embodiments, at least one (e.g. base, e.g. top) frame member of the plurality of (e.g. base, e.g. top) frame members has all (e.g. both) of its ends having the second diameter.

In some embodiments, at least one (e.g. base, e.g. top) frame member of the plurality of (e.g. base, e.g. top) frame members has at least one end (e.g. one) having the second diameter and at least one (e.g. one) other end having the first diameter. For example, at least one (e.g. base, e.g. top) frame member of the plurality of (e.g. base, e.g. top) frame members has two ends, one of the two ends having the first diameter and the other of the two ends having the second diameter.

Optionally, any two (e.g. base, e.g. top) frame members of the plurality of (e.g. base, e.g. top) frame members are connected together by inserting an end of one of the frame members having the second diameter into an end of the other frame member having the first diameter.

In some embodiments, the (e.g. base, e.g. top) frame members are made from a material comprising aluminium. For example, the (e.g. base, e.g. top) frame members may be made from aluminium. As aluminium is very lightweight, this has the advantage that the frame assembly provided is very lightweight and easily moveable to the roof of a vehicle, even by a single user.

In some embodiments, the base frame has a substantially rectangular shape. Preferably, the base frame has a substantially rectangular shape when viewed in plan. The plan view may be considered to be the view when looking down on the roof tent from above the roof of the vehicle. In other words, the base frame has a substantially rectangular cross-sectional shape in a plane parallel to the roof of the vehicle when the roof tent is mounted on the roof.

In some embodiments, the base frame defines the perimeter of a three-dimensional shape having a first cross-sectional shape in a first plane and a second cross-sectional shape in a second plane, where the second plane is perpendicular to the first plane. The first plane may be considered to be the plane parallel to the roof of the vehicle (i.e. when the roof tent is mounted on the roof). The second plane may be considered to be either of two the two planes perpendicular to the roof (i.e. when the roof tent is mounted on the roof). Optionally, the first cross-sectional shape is substantially a quadrilateral, e.g. substantially a rectangle. Optionally, the second cross sectional is substantially a quadrilateral, e.g. substantially a rectangle or a trapezoid. Within the meaning of the present invention, a quadrilateral (e.g. a rectangle, e.g. a trapezoid) having rounded, fileted or chamfered corner is substantially a quadrilateral (e.g. a rectangle, e.g. a trapezoid).

In some embodiments, the base frame comprises a plurality of (base) frame members connected together to define the perimeter of the first cross-sectional shape. For example, the base frame may comprise a plurality of first (base) frame members lying in the first plane and at least one second (base) frame member lying in the second plane. Preferably, the at least one second (base) frame member is connected to at least one of the plurality of first (base) frame members. Preferably, at least part of the at least one second (base) frame member lies in the first plane, and at least part of the at least one second (base) frame member extends out of the first plane (e.g. in the second plane). Optionally, at least part of the at least one second (base) frame member lies in a plane parallel and offset from the first plane. Preferably, the mounting means is (e.g. reversibly) attached to at least one (e.g. one, e.g. two, e.g. three, e.g. four) second (base) frame member(s).

In some embodiments, the three-dimensional shape of the base frame has a top surface, a bottom surface and a depth, wherein the top surface defines a plane substantially parallel to, and offset from, the roof of the vehicle (e.g. when the roof tent is installed on the roof), the bottom surface defines a plane substantially parallel to, and offset from, the roof of the vehicle (e.g. when the roof tent is installed on the roof), and the depth defines the dimension extending between the top surface and the bottom surface. It will be appreciated that the bottom surface is closer to the roof of the vehicle than the top surface, or put another way, the top surface is offset from the roof to a greater extent than the bottom surface. Preferably the top surface and the bottom surface and parallel to each other and to the roof of a vehicle in use. Preferably, the bottom surface comprises part of the base frame (e.g. part of the second (base) frame members) that engages with the mounting means to (reversibly) attach the base frame to the roof of the vehicle (via the mounting means).

In some embodiments, the roof tent further comprises a flexible body configured to provide a (e.g. resilient) surface for supporting a load (e.g. a user) within the tent. Within the meaning of the present invention, a resilient surface is a surface that can give, flex and/or bend (e.g. under the weight of a person sitting or lying prone on the surface) but that substantially returns to its original position when the load (e.g. user) is removed. Within the meaning of the present invention the flexible body may be made of or comprise a textile material or any suitable and/or desirable flexible sheet or material. For example, the flexible body may comprise or be made from any suitable and/or desirable cloth or fabric material (e.g. a woven material, e.g. a netting material), a polymeric material (e.g. a rubber or neoprene sheet) or a plastic sheet material (e.g. an extruded sheet material). The flexible body may also be made from a continuous sheet of material such that the fabric body provides a substantially “solid” surface (i.e. a surface absent holes or apertures) for a user to lie on. Alternatively, the flexible body may be made from a plurality of straps or pieces of material woven together to form a surface having apertures or holes extending there through.

In some embodiments, the flexible body is attached to the frame assembly. Optionally, the flexible body is attached to the base frame. Because the frame assembly (e.g. the base frame and/or the top frame) are reversibly assembled from a plurality of frame members, the flexible body may further serve the function of retaining the frame assembly (e.g. the base frame) in the assembled configuration.

Optionally, the (e.g. resilient) surface provided by the flexible body is substantially coincident with the top surface of the three-dimensional shape defined by the base frame. Preferably, upon receipt of the load (e.g. the user), the flexible body flexes in a direction towards the bottom surface of the three-dimensional shape of the base frame. In other words, the flexible body extends into the interior volume of the three-dimensional shape of the base frame. In this way, the flexible body provides a springy surface onto which a user may rest (e.g. sit or lie) which improves the comfort of the user.

In some embodiments, the flexible body comprises a plurality of attachment means configured to attach the flexible body to the base frame (e.g. to the first frame members). The attachment means may be any suitable and/or desirable attachment means, such as (but not limited to) straps, toggles and loops, velcro and/or ropes. Optionally, at least one of the attachment means is provided by folding over the material of the flexible body to provide a loop through which a (e.g. base, e.g. first base) frame member may be inserted. Preferably the attachment means provide a reversible attachment.

Optionally, at least one of the attachment means includes an adjustable tension means which allows the flexible body to be tensioned. As such, the tension means allows the user to attach the flexible body to the base frame easily (i.e. because the fabric is slack and not under tension) and then use the tensioning means to provide the (e.g. resilient) surface under a desired tension. The tension means may be any suitable and/or desirable means. Preferably, the tension means is a tension strap and ratchet buckle. By tensioning the flexible body whilst it is attached to the frame assembly (e.g. the base frame) the frame assembly (e.g. the base frame) is itself tensioned such that the frame members are more securely held together.

In some embodiments, the first portion comprises tethering means to connect the first portion to the base frame. Optionally, the tethering means connect the first portion to the (e.g. first base) frame members. The tethering means may be any suitable and/or desirable means, for example, straps, buckles, Velcro, toggles and loops. Preferably, the tethering means provides a reversibly attachment between the first portion and the base frame.

In some embodiments, the tethering means of the first portion do not overlap with the attachment means of the flexible body. Preferably, when the flexible body is attached to the base frame (e.g. attached to the first (e.g. base) frame members), a plurality of areas of the frame (e.g. the first (e.g. base) frame members) remain exposed and thus provide a site of attachment to the tethering means.

In some embodiments, the top frame has a substantially rectangular shape. Preferably, the top frame has a substantially rectangular shape when viewed in plan. The plan view may be considered to be the view when looking down on the roof tent from above the roof of the vehicle. In other words, the top frame has a substantially rectangular cross-sectional shape in a plane parallel to the roof of the vehicle when the roof tent is mounted on the roof.

In some embodiments, the top frame defines the perimeter of a three-dimensional volume having a first cross-sectional shape in a first plane and a second cross-sectional shape in a second plane, where the second plane is perpendicular to the first plane. The first plane may be considered to be the plane parallel to the roof of the vehicle (i.e. when the roof tent is mounted on the roof). The second plane may be considered to be either of two the two planes perpendicular to the roof (i.e. when the roof tent is mounted on the roof). Optionally, the first cross-sectional shape is substantially a quadrilateral, e.g. substantially a rectangle. Optionally, the second cross sectional is substantially a polygon, e.g. substantially a three-sided polygon (e.g. a triangle, e.g. a scalene or obtuse triangle), e.g. a four-sided polygon (e.g. a rectangle or a trapezoid). Within the meaning of the present invention, a polygon (e.g. a triangle, e.g. a rectangle, e.g. a trapezoid) having rounded, fileted or chamfered corner is substantially a polygon (e.g. a rectangle, e.g. a trapezoid).

Optionally, when the top frame is in the first position, the first plane of the top frame is parallel to (and substantially coincident with) a plane comprising the top surface of the three-dimensional volume defined by the base frame. In other words, when the top frame is in the first position the top frame and base frame engage along at least two sides such that the roof tent is closed or stowed. Optionally, when the top frame is in the second position, the first plane of the top frame intersects the plane comprising the top surface of the base frame at an angle of intersection (e.g. the interior angle between the top surface and the first plane of the top frame). Preferably, the angle of intersection is from 5 degrees to 45 degrees, e.g. from 15 degrees to 35 degrees, e.g. from 20 degrees to 30 degrees, e.g. approximately 25 degrees.

In some embodiments, when the top frame is in the first position (e.g. the stowed configuration), the top frame and the base frame form a cage arrangement. In other words, when the top frame is in the first position, the frame assembly defines the perimeter of a fully enclosed volume.

In some embodiments, the base frame is attached to the top frame by a fastening means. Optionally, the fastening means allow the top frame to pivot relative to the base frame such that the top frame can move about a pivot axis between a first position and a second position. Optionally, at least part of the fastening means sits on the pivot axis. In some embodiments, the fastening means are at least one of a hinge or clip which are configured to allow the base frame and the top frame to pivot with respect to each other. In some embodiments, part of the top frame (e.g. a (e.g. top) frame member) may rotate within (e.g. with respect to) the fastening means (e.g. a clip). Preferably, the fastening means is removable and/or detachable.

In some embodiments, the roof tent further comprising a canopy arrangement which defines the interior of the roof tent. The canopy arrangement may be provided to the user as a single piece or canopy pod which is configured to surround the frame assembly. For example, the canopy pod may comprise an opening that allows the canopy arrangement to fit over the frame portion. For example, the opening may form the door of the roof tent. Alternatively, the canopy arrangement can be formed from a plurality of portions that may be attached together to form the canopy arrangement. For example, the canopy arrangement may comprise a first portion and a second portion. Optionally, the first portion may be connected to the base frame. Optionally, the second portion may be connected to the top frame. Optionally, the first portion and the second portion are (e.g. reversibly) attached together (e.g. by an attachment means).

In some embodiments, the canopy arrangement encloses at least part of the frame assembly such that the canopy arrangement defines an interior volume of the tent. Optionally, the canopy arrangement encloses all of the top frame. Optionally, the canopy arrangement encloses all of the top frame and part of the base frame. Optionally, the canopy arrangement encloses (e.g. substantially) all of the frame assembly, e.g. all of the (e.g. top, e.g. base) frame members forming the frame assembly are enclosed within the canopy arrangement.

In some embodiments, the first portion has a base portion and a wall portion. Optionally, the base portion is connected to the base frame. Optionally, when the top frame is in the second position, the wall portion extends from the base portion to the second portion and provides the walls of the opened roof tent. Optionally, when the top frame is in the first position, the wall portion is folded within the frame assembly (e.g. the wall portion is enclosed within the cage arrangement formed by the frame assembly).

In some embodiments, the wall portion comprises an attachment means to attach the wall portion to the second portion. Preferably the attachment means is any suitable and/or desirable attachment means. For example, the attachment means may be (part of) a zip, toggles or ropes and ties. Preferably, the second portion comprises a complementary attachment means (e.g. part of a zip, e.g. a toggle, e.g. a tie) to engage with the attachment means of the wall portion to attach the wall portion to the second portion.

In some embodiments, the second portion comprises a skirt, wherein the skirt may be configured to overhang the top-frame such that when the top-frame is in the first position, the skirt overlaps the base portion. Preferably, the complementary attachment means is provided proximate to the top frame such that the skirt covers the attachment between the wall portion and the second portion in use. This provides the benefit of improving the waterproofing of the roof tent such that the attachment between the wall portion and the second portion is covered by the skirt.

In some embodiments, the second portion (e.g. the skirt) comprises a tensioning means configured to tighten the skirt around the base portion. For example, the tensioning means may be an elasticated edge or a toggle and cord, wherein the cord is attached around the edge of the second portion (e.g. around the edge of the skirt).

In some embodiments, the first potion (e.g. the base portion of the first portion) comprises a plurality of apertures. In some embodiments, the apertures are configured to allow the base frame to be attached to the mounting means. For example, the apertures may receive a fixing means (e.g. a bolt or screw) that joins the mounting means to the base frame (e.g. to a second (e.g. base) frame member). In some embodiments, the apertures are configured to allow part of the base frame (e.g. part of a second (e.g. base) frame member) to extend through the aperture such that the mounting means is attached to the base frame outside of the canopy arrangement.

In some embodiments, the first portion (e.g. the base portion) is sandwiched between the base frame (e.g. a second (e.g. base) frame member) and the mounting means. Optionally, the first portion (e.g. the base portion) further comprises a reinforcing means where the first portion engages both the mounting means and the base frame. For example, the reinforcing means may be a reinforcing strip of material. This improves the durability of the roof tent and ensures that movement of the mounting means with respect to the frame base and/or canopy arrangement does not rip or tear or otherwise compromise the integrity of the roof tent.

In some embodiments, the canopy arrangement (e.g. wall portion) further includes features such as a window or door to allow a user to enter and exit the interior of the tent.

In some embodiments, the second portion comprises at least one attachment means configured to attach the second portion to the top frame. In some embodiments, the second portion does not comprise an attachment means. In such embodiments, the second portion may be held in place by virtue of the attachment to the first portion. For example, the second portion is attached to the first portion such that, when the roof tent is in the open configuration, the canopy arrangement is pulled substantially taught around the frame assembly (e.g. the second portion is held in place proximate to the top frame).

In some embodiments, the canopy arrangement is made from a waterproof material, e.g. a material comprising polyester. Optionally, the first portion and the second portion are made from the same material. Optionally, the base portion and the second portion are made from the same material. Optionally, the wall portion is made from a different material to the base portion. Optionally the wall portion is made from a material that is more flexible than the material of the base portion and/or the second portion.

It will be appreciated that the functions of the first portion (e.g. the base portion and/or the wall portion) and the second portion may dictate the materials to provide these parts. For example, the top portion of the canopy arrangement may need to be made from a more durable fabric than, for example, the wall portion, because the top portion is permanently exposed and thus required to withstand environmental conditions such as stones being flicked up from a road surface as the vehicle is moving. In contrast, the wall portion, which is only exposed when the roof tent is provided in the open configuration (i.e. when the vehicle is stationary) needs to be durable to environmental conditions that may be experienced during use (e.g. wind or rain) which may be less severe.

In some embodiments, the canopy arrangement further comprises at least one aperture proximate to the frame assembly such that an accessory may be inserted through the at least one aperture and engage with the frame assembly. Optionally, the first portion comprises at least one aperture configured to be proximate to a frame member (e.g. the first (e.g. base) frame member) of the base frame assembly when the first portion is attached to the base frame. Optionally, the base portion comprises at least one aperture configured to be proximate to a frame member (e.g. the first (e.g. base) frame member) of the base frame assembly when the first portion is attached to the base frame. In this way, the frame assembly (e.g. the base frame) supports the load of the accessory, not the canopy arrangement. As such, heavy accessories may be attached to the roof tent without risking the canopy arrangement tearing under the weight. Optionally, the apertures are covered by a flap, e.g. to ensure weatherproofing

In some embodiments, the accessory is a ladder, for example a rope ladder, configured to allow a user to access the roof of the vehicle and thus the interior of the tent. Optionally, the accessory (e.g. ladder) comprises a hooked end configured to engage (e.g. hook) onto part of the base frame (e.g. a (e.g. first, e.g. base) frame member).

In some embodiments, the root tent further comprises a retaining mechanism configured to hold the top frame in the second position. Optionally, the retaining mechanism is selected to be one of a strut, a pole, a collapsible tent pole, a folding support strut or a gas strut. For example, the retaining mechanism may be at least one pivotable arm, wherein the arms may comprise a central pivot (that allows the arms to fold back on themselves them the roof tent in its stowed position) and a locking means (that allows the arms to be reversibly locked into a retaining configuration (e.g. where the two arms are substantially collinear).

Optionally, the retaining mechanism is fixedly attached to both the top frame and the bottom frame. In such embodiments, the retaining mechanism is configured to move between a first position (in which it retains the top frame in the open configuration) and a second position (in which the mechanism does not retain a load and/or is enclosed within the interior of the cage arrangement.

It will be appreciated that the mounting means may be any desirable mounting means configured to engage with the roof of a vehicle (e.g. configured to engage with the roof bars of a vehicle). For example, the mounting means may be mounts, bars, rails or beams.

In a third aspect of the invention, a kit of parts for a roof tent is provided. Optionally, the kit of parts comprises a mounting means for mounting the roof tent on a roof of a vehicle. Optionally, the kit of parts comprises a plurality of (e.g. base) frame members configured to be connected to provide a base frame. Optionally, the kit of parts comprises a plurality of (e.g. top) frame members configured to be connected to provide a base frame. Optionally, the kit of parts comprises a fastening means configured to engage with a (e.g. base) frame member and a (e.g. top) frame member to allow the top frame to pivot between a first position and a second position relative to the base frame when both the top frame and the base frame are assembled. Optionally, the kit of parts comprises a canopy arrangement comprising a first portion and a second portion, wherein the first portion is connectable to the base frame, and the second portion is connectable to the top frame. Optionally, the first portion and the second portion each comprise attachment means configured to allow the first portion and the second portion to be attached together.

In a fourth aspect of the invention, a kit of parts for a roof tent is provided, the kit of parts comprising:
a mounting means for mounting the roof tent on a roof of a vehicle;
a plurality of frame members configured to be connected to provide a frame assembly.

It will thus be appreciated that the third and fourth aspects of the invention both provides a kit of parts suitable for making or assembling the roof tent of the first and/or second aspects of the invention. As such, the features and/or embodiments described above with regards to the first and second aspects of the invention apply equally to the third and fourth aspects of the invention.

### BRIEF DESCRIPTION OF THE DRAWINGS

The accompanying drawings, which are incorporated in and constitute a part of the specification, illustrate embodiments of the disclosure and together with the detailed description herein, serve to explain the principles of the disclosure. It is emphasized that, in accordance with the standard practice in the industry, various features are not drawn to scale. In fact, the dimensions of the various features may be arbitrarily increased or reduced for clarity of discussion. The drawings are only for purposes of illustrating preferred embodiments and are not to be construed as limiting the disclosure:

FIGS. 1A and 1B show a side-view of a roof tent in both the open configuration (FIG. 1A) and the closed or stowed configuration (FIG. 1B), in accordance with an aspect of the present disclosure;

FIGS. 2A and 2B show a side-view of a roof tent in both the open configuration (FIG. 2A) and the closed or stowed configuration (FIG. 2B), in accordance with an aspect of the present disclosure;

FIGS. 3A and 3B show a perspective view of a base frame in an assembled form (FIG. 3A) and expanded into its constituent frame members (FIG. 3B), in accordance with an aspect of the present disclosure;

FIGS. 4A and 4B show a perspective view of a top frame in an assembled form (FIG. 4A) and expanded into its constituent frame members (FIG. 4B), in accordance with an aspect of the present disclosure;

FIG. 5 shows a perspective view of a frame assembly, in accordance with an aspect of the present invention;

FIGS. 6A AND 6B show a perspective view (FIG. 6A) and a side view (FIG. 6B) of a canopy arrangement, in accordance with an aspect of the present invention.;.

FIG. 7 shows a perspective view of a first portion of a canopy arrangement, in accordance with an aspect of the present invention;

FIG. 8 shows a perspective view of the underside of the second portion of a canopy arrangement, in accordance with an aspect of the present invention;

FIG. 9 shows a plan view of the base assembly including a flexible body, in accordance with an aspect of the present invention;

FIGS. 10A AND 10B show a side view of a roof tent (FIG. 10A) and a cross-sectional view of the enlarged portion of FIG. 10A (FIG. 10B), in accordance with an aspect of the present disclosure; and

FIGS. 11A AND 11B show a side view of a roof tent (FIG. 11A) with an accessory ladder (shown in FIG. 11B), in accordance with an aspect of the present invention.

### DETAILED DESCRIPTION FOR CARRYING OUT THE INVENTION

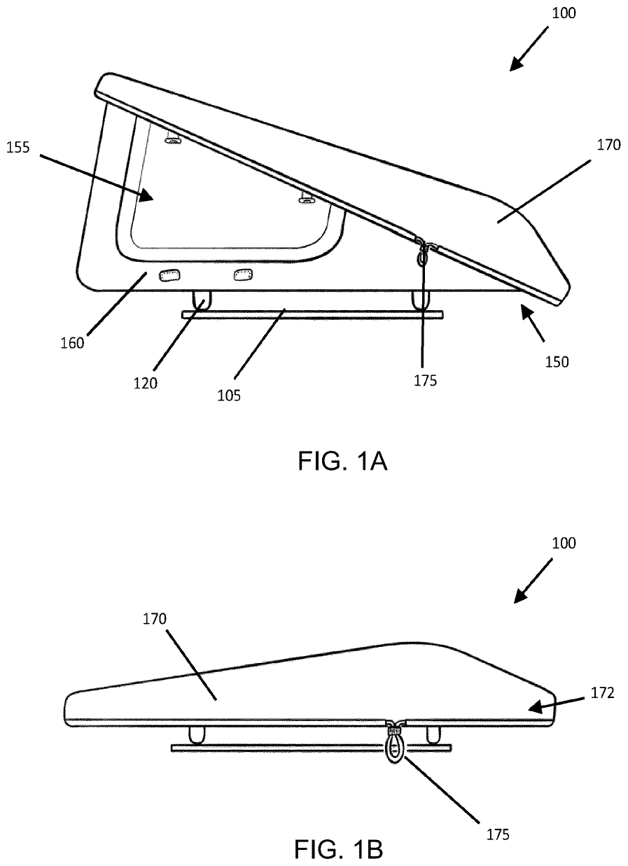

FIG. 1A shows a side-view of a roof tent 100 in the open configuration such that a user may enter the interior 155 of the roof tent 100. The roof tent 100 includes a mounting means 105 which can be attached to both the base frame 120 and the roof of a vehicle (not shown) to attach the roof tent 100 to the roof. Although the mounting means 105 is shown as a rail, it may be appreciated that the mounting means 105 may be any suitable and/or desirable means. The roof tent 100 includes a canopy arrangement 150 which includes a first portion 160 and a second portion 170. The canopy arrangement 150 defines the interior of the tent 155 such that the first portion 160 provides the base and roof of the tent 100 and the second portion 170 provides the roof of the tent. As shown in FIG. 1A, part of the base assembly 220 extends out from the canopy arrangement 150 such that only some of the frame assembly is enclosed within the interior 155 of the roof tent 100.

As shown in FIG. 1A, when the roof tent 100 is provided in the open configuration (i.e. the top frame is in the second position), the top frame (which provides the structural elements to which the second portion 170 is attached) is provided at an angle with respect to the base of the roof tent 100.

As shown in FIG. 1B, when the roof tent 100 is provided in the closed configuration, the top frame is in the first position and the second portion 170 includes a skirt 172 that substantially obscures the base frame and the first portion 160 from view. The second portion 170 includes a tensioning means 175 in the form of a rope and toggle along the edge of the second portion 170 such that the tensioning means can be used to tighten the second portion 170 around the base frame and ensure waterproofing during travel and/or whilst stowed.

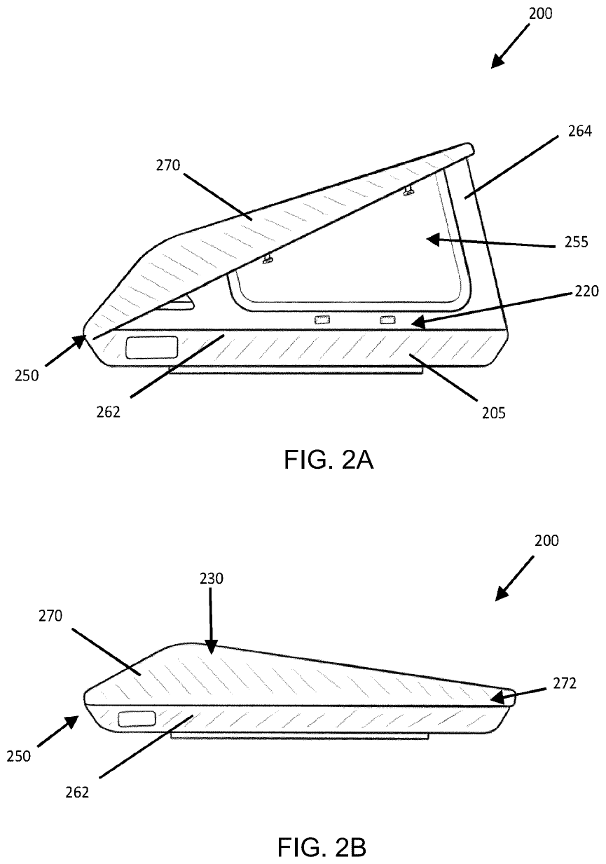

FIG. 2A shows a side-view of a roof tent 200 in accordance with another embodiment of the present invention in the open configuration such that a user may enter the interior 255 of the roof tent 200. The roof tent 200 (as with the roof tent 100 shown in FIGS. 1A and 1B) includes a mounting means 205 which can be attached to both the base frame 220 and the roof of a vehicle (not shown) to attach the roof tent 200 to the roof. Although the mounting means 205 is shown as a rail, it may be appreciated that the mounting means 205 may be any suitable and/or desirable means.

The roof tent 200 includes a canopy arrangement 250 which includes a first portion 260 and a second portion 270. The canopy arrangement 250 defines the interior of the tent 255. However, unlike the roof tent 100 shown in FIGS. 1A and 1B, in the embodiment shown in FIGS. 2A and 2B, the first portion 260 comprises a base portion 262 and a wall portion 264, wherein the base portion 262 provides the base of the roof tent 200, the wall portion 264 provides the walls of the roof tent 200. The second portion 270 provides the roof of the tent.

Unlike the roof tent 100 shown in FIGS. 1A and 1B, the canopy arrangement 250 of the roof tent 200 completely encloses the frame assembly such that all parts of the frame assembly 250 are contained within the interior of the tent 255.

Unlike the roof tent 100 shown in FIGS. 1A and 1B, in the embodiment shown in FIG. 2B, when the roof tent 200 is provided in the closed configuration, the second portion 270 has a skirt 272 that overlaps, but does not completely obscure the base frame 220 and the first portion 260 from view.

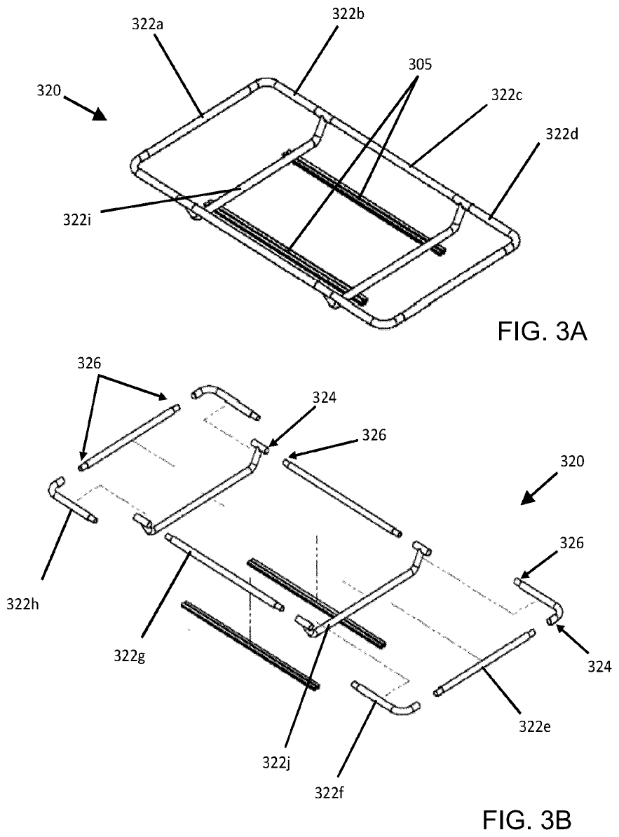

FIG. 3A shows a perspective view of an assembled base frame 320 and FIG. 3B shows the base frame 320 expanded into its constituent base frame members 322a-j. As shown, the base frame 320 comprises a number of first base frame members 322a-h which, when connected together, form a rectangular frame in a first plane. The base frame also contains two second base frame members 322i, 322j which extend out of the plane defined by the first frame members 322a-322h. The base frame members 322a-322i thus define a three-dimensional volume with a substantially rectangular prism shape, wherein the first base frame members 322a-322h define the rectangular shape in the first plane and the second base frame members 322i, 322j provide a depth to the three-dimensional volume. The base frame is attached to the mounting means 305 (shown as a rail) by the second base frame members 322i, 322j.

As shown in FIG. 3B, the base frame members are elongate tubular members having at least two ends, wherein the ends may have either a first diameter 324 or a second diameter 326. The first diameter 324 is substantially the same diameter as the diameter of the elongate tubular members body (i.e. its diameter at its centre). In contrast, the second diameter 326 is less than the first diameter 324. As such, an end of a base frame member 322a-322j having the second diameter 326 may be inserted into an end of another base frame member 322a-322j having a first diameter 324 such that friction between the two ends of different frame members holds the frame members together.

Some of the base frame members 322a, 322c, 322e, 322g have two ends, each of which having the second diameter. Some of the base frame members 322b, 322d, 322f, 322h have two ends, one of which has the first diameter and one of which has the second diameter. Some of the base frame members (e.g. the two second base frame members) 322i, 322j have four ends, each of which have the first diameter. The frame members 322a-322j are therefore configured such that they can be reversely attached together by a friction fit.

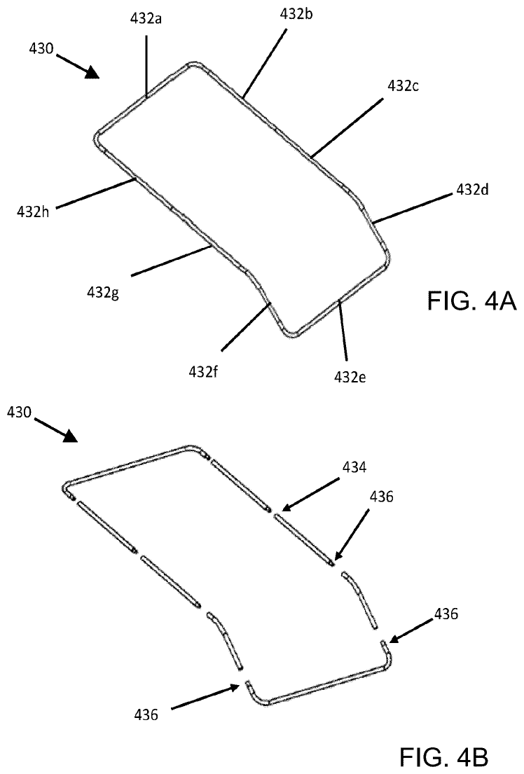

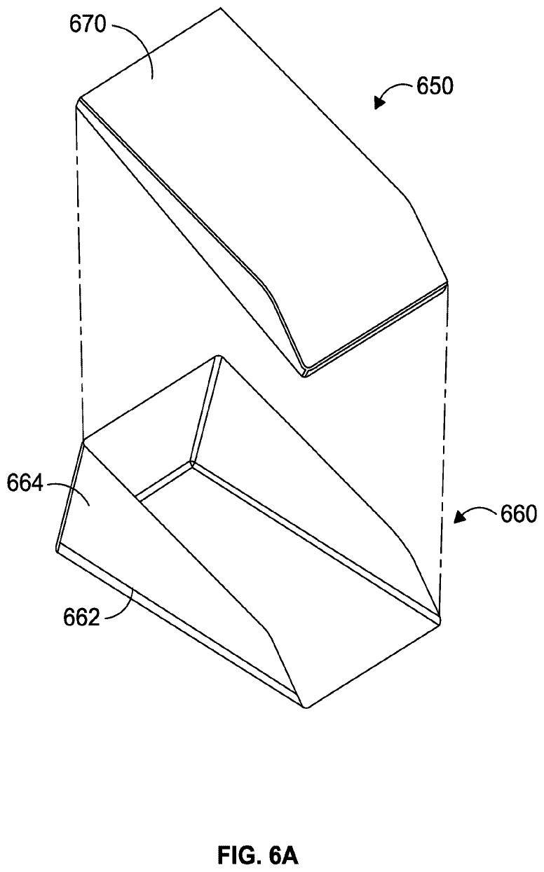

FIG. 4A shows a perspective view of a top frame 430 in an assembled form and FIG. 4B shows the top frame 430 expanded into its constituent top frame members 432a-432h. As shown, the top frame 420 comprises a number of the top frame members 432a-h which, when connected together, form a rectangular frame in a first plane (i.e. when viewed from the top down) and a triangular shape in a second frame (see FIG. 6B).

As with the base frame members 322a-322j, the top frame members 432a-432h are elongate tubular members having at least two ends, wherein the ends may have either a first diameter 434 or a second diameter 436. The first diameter 434 is substantially the same diameter as the diameter of the elongate tubular members body (i.e. its diameter at its centre). In contrast, the second diameter 436 is less than the first diameter 434. As such, an end of a top frame member 432a-432h having the second diameter 436 may be inserted into an end of another top frame member 432a-432h having a first diameter 434 such that friction between the two ends of different frame members holds the frame members together.

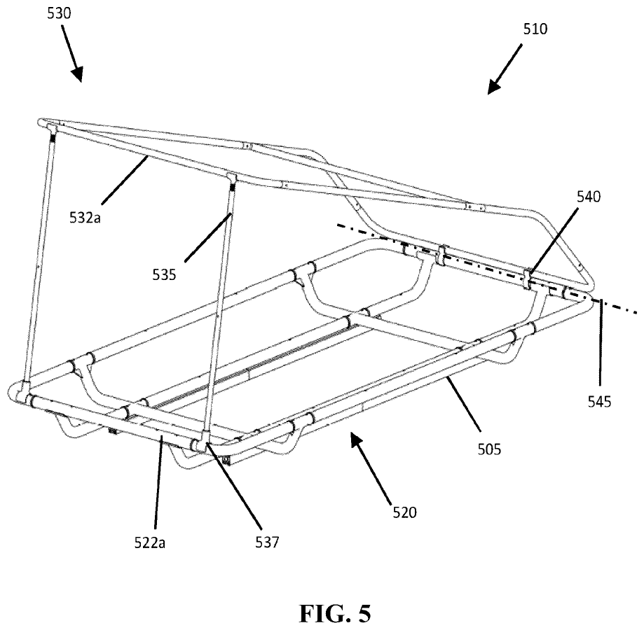

FIG. 5 shows a perspective view of a frame assembly 510. The frame assembly 510 is formed form the base frame 520 and the top frame 530. The base frame 520 is attached to the mounting means 505 (shown in the form of a rail). The base frame 520 is further attached to the top frame 530 by a fastening means 540, shown as a clip. The fastening means 540 allows the top frame 530 to pivot relative to the base frame 520 (about a pivot axis 545 between a first position and a second position. As shown in FIG. 5, the pivot axis 545 lies between the base frame member and the top frame member which are connected together by the fastening means 540. As such, the clip sit on (e.g. surrounds) the pivot axis 545 and the base frame 520 and the top frame 530 are always in contact along an edge of the frame assembly.

To hold the top frame 530 in the open configuration, two retaining rods 535 are provided between the base frame 520 and the top frame 530. The retaining rods 535 reversibly attach to a base frame member 522a and a top frame member 532a by clips such that the retaining rod 535 prevents the top frame 530 from pivoting (e.g. under the force of gravity) towards the base frame 520. The retaining rods 535, base frame 520 and top frame 530 thus provide an interior volume of the roof tent inside which a user may sit.

When the frame assembly 510 is provided in the closed configuration (i.e. the top frame 530 is in the first position), the base frame member 532a and the top frame member 522a come into contact. As such, the base frame 520 and the top frame 530, when in the closed configuration, are in contact along two edges of the frame assembly.

An embodiment of the canopy arrangement 650 is shown in perspective view in FIG. 6A and in side view in FIG. 6B. The canopy arrangement 650 includes a second portion 670 and a first portion 660. The first portion 660 itself includes a base portion 662 (forming the base of the tent interior, and a wall portion 664 (forming the walls of the tent.

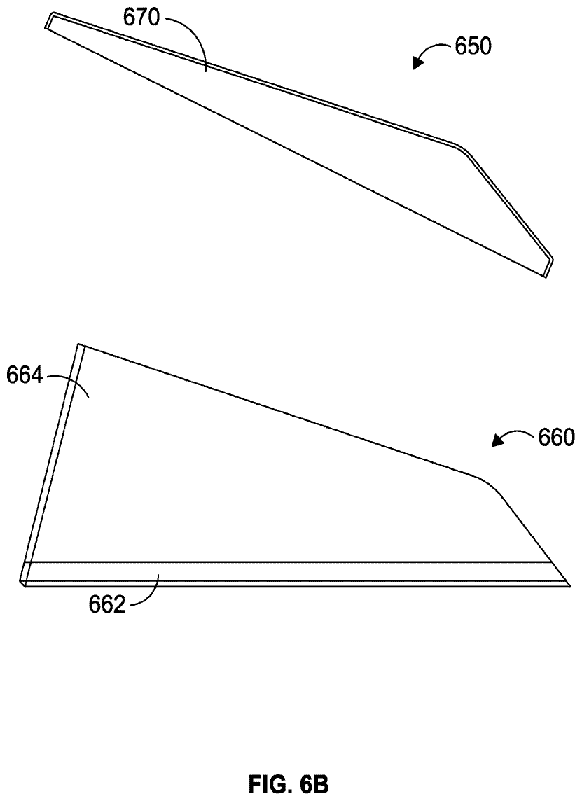

FIG. 7 shows a perspective view of an embodiment of the first portion 760 of a canopy arrangement. The first portion 760 contains a base portion 762 and a wall portion 764. The wall portion 764 also includes a zip 768 which provides a means to attach the wall portion 764 to a second portion (not shown) of the canopy arrangement. The base portion 760 includes a plurality of tethering means 766, the form of buckles and straps, which are arranged to attach the first portion 760 to the base frame (not shown).

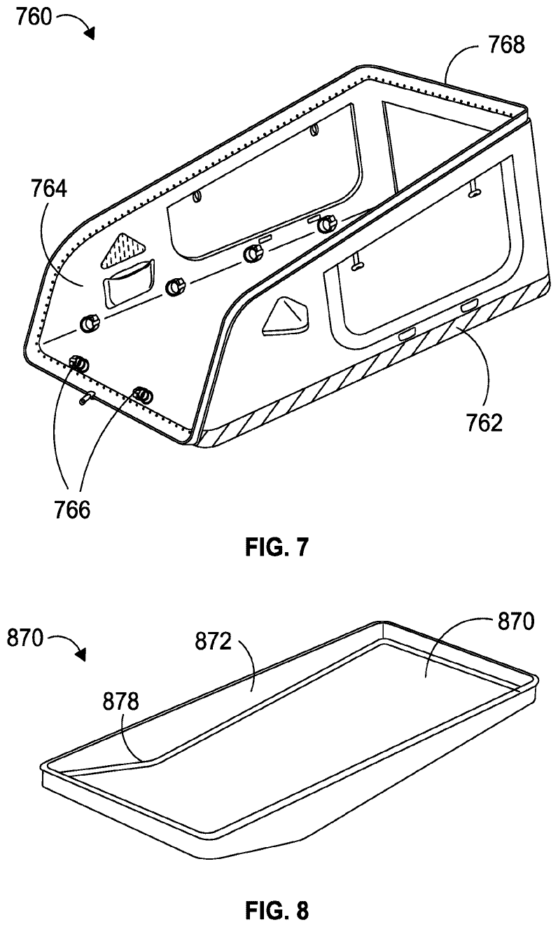

FIG. 8 shows a perspective view of the underside of an embodiment of the second portion 870 of a canopy arrangement. As shown, the second portion 870 includes a skirt 872 and a complementary attachment means 878 to the attachment means 768 shown in FIG. 7 on the wall portion 764. As such, the complementary attachment means in the form of a zip 878 and the attachment means 767 connect the wall portion 764 to the second portion 870.

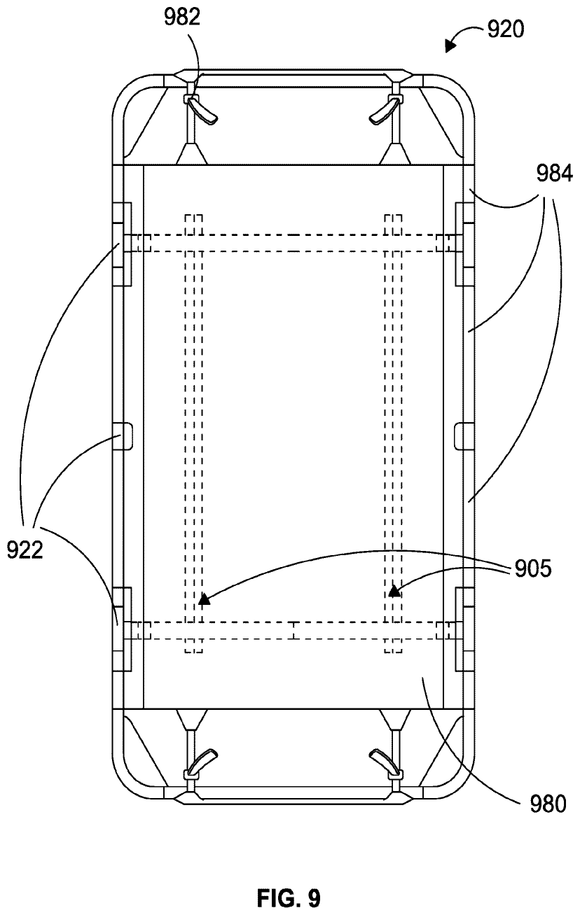

FIG. 9 shows a plan view of an embodiment of the base frame 920 including a flexible body 980. The flexible body 980 includes a plurality of attachment means 984 in the form of material loops through which the frame members of the base frame 920 may be inserted. The attachment means 984 are arranged such that they leave a plurality of spaces 922 along the frame members which can be used by the tethering means of the base portion (as shown in FIG. 7) to attach the base portion to the base frame 920.

The flexible body 980 is shown to be tensioned (e.g. the fabric is held taught across the base frame 920 to provide a resilient surface). The tension is achieved using the tensioning means 982, shown as a strap and ratchet buckle, which, after the base frame 920 has been assembled, may be used to tighten the flexible body 980 across the base frame 920. As shown, the flexible body 980 lies in a plane above the mounting means 905 such that the resilient surface formed by the flexible body 980 may flex into the volume defined by the base frame 920 when a user is present on the surface.

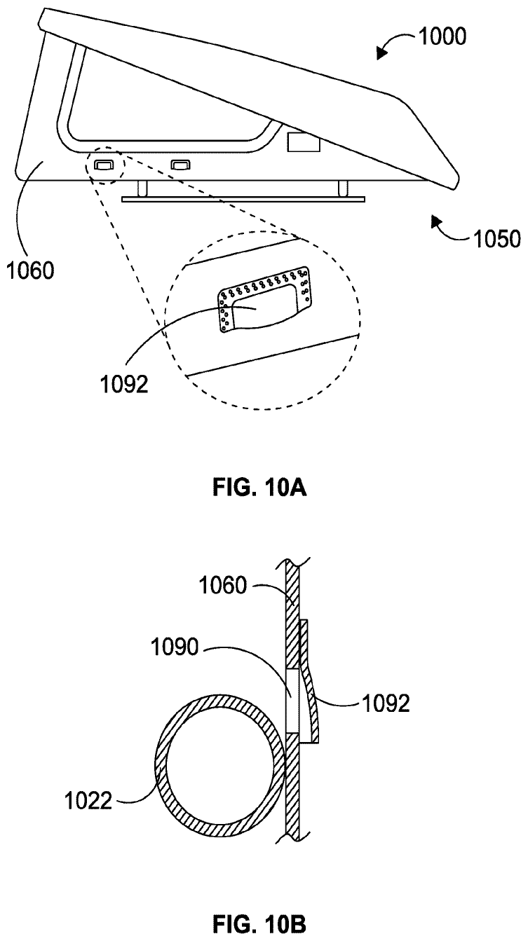

FIG. 10A shows a side view of an embodiment of a roof tent 1000 including an aperture 1090 (shown in FIG. 10B) in the first portion 1060 of the canopy arrangement 1050. The aperture 1090 is concealed (or covered) by a flap 1092 to maintain the waterproofed integrity of the roof tent 1000. The aperture 1092 is positioned proximate to a (e.g. base) frame member 1022 of the base frame such that an accessory extending through the aperture 1092 may engage with the (e.g. base) frame member 1022 of the base frame. As such, the (e.g. base) frame member 1022 of the base frame carries the load of the accessory, not the canopy arrangement, reducing the risk of tearing.

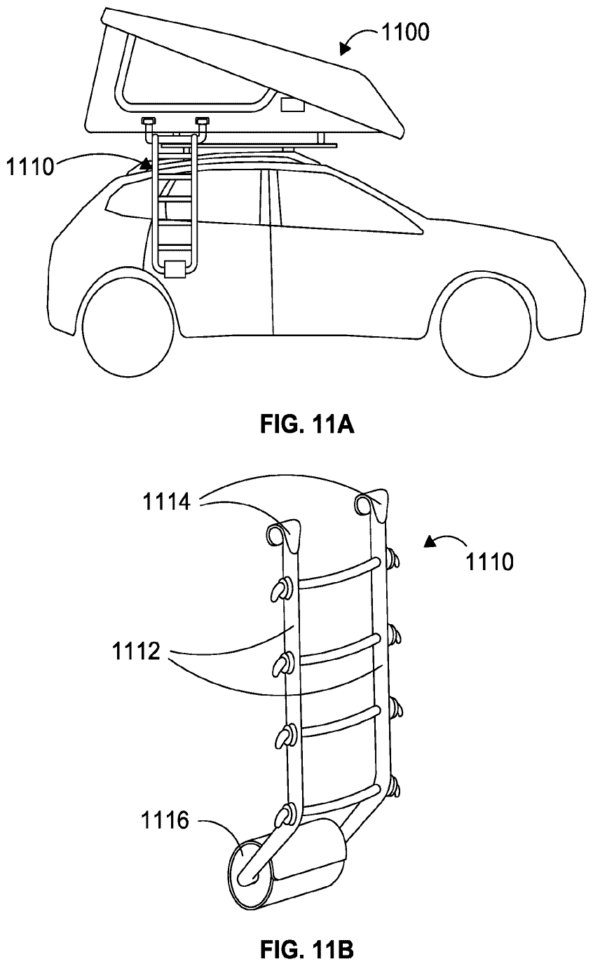

FIGS. 11A and 11B shows an example of a roof tent 1100 having an accessory 1110 attached. In the depicted example, the accessory is a ladder having rungs made of rope and two rigid arms 1112 in accordance with an embodiment of the present invention. The rigid arms 1112 terminate in hooks 1114 that are configured to engage with the frame members of the base frame (as shown in FIG. 10B). The ladder further includes a cushioning means 1116 which protects the side of the car from being scratched by the ladder in use.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or roof tent that comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a roof tent or structure that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

What is claimed is:

1. A roof tent, the roof tent comprising:
a mounting means for mounting the roof tent on a roof of a vehicle; and
a frame assembly attached to the mounting means, wherein the frame assembly is formed by a plurality of frame members that are reversibly connected such that the frame assembly is reversibly assembled.

2. The roof tent of claim 1, wherein the frame assembly comprises:
a base frame attached to the mounting means; and
a top frame attached to the base frame;
wherein the base frame assembly is formed by a plurality of frame members that are reversibly attached such that the base frame assembly is reversibly assembled;
and, wherein the top frame is formed by a plurality of frame members that are reversibly attached such that the top frame is reversibly assembled.

3. The roof tent of claim 2, wherein the base frame is attached to the top frame by a fastening means, wherein the fastening means allow the top frame to pivot relative to the base frame such that the top frame can move about a pivot axis between a first position and a second position.

4. The roof tent of claim 1, wherein the frame members are tubular members having a connection means at each end.

5. The roof tent of claim 1, wherein roof tent further comprises a flexible body configured to provide a resilient surface for supporting a load within the tent.

6. The roof tent of claim 5, wherein the at least part of the frame assembly defines a three-dimensional shape having a top surface, a bottom surface and depth, wherein both the top surface and the bottom surface are parallel to each other;
wherein the resilient surface provided by the flexible body is substantially coincident with the top surface of the three-dimensional shape defined by the base frame; and
wherein upon receipt of the load, the flexible body flexes in a direction towards the bottom surface of the three-dimensional shape upon receipt of the load.

7. The roof tent of claim 5, wherein the flexible body comprises a plurality of attachment means to attach the flexible body to the frame assembly, preferably to the base frame.

8. The roof tent of claim 7, wherein at least one of the attachment means includes an adjustable tension means that allows the flexible body to be tensioned to provide the resilient surface, wherein the tension means is optionally a tension strap and ratchet buckle.

9. The roof tent of claim 2, wherein the roof tent further comprises a canopy arrangement, the canopy arrangement comprising a first portion connected to the base frame and a second portion connected to the top frame.

10. The roof tent of claim 9, wherein the first portion comprises tethering means to connect the first portion to the base frame.

11. The roof tent of claim 10, wherein the tethering means of the first portion do not overlap with the attachment means of the flexible body.

12. The roof tent of claim 2, wherein the top frame defines the perimeter of a three-dimensional volume having a substantially rectangular cross-sectional shape in a first plane and a substantially triangular second cross-sectional shape in a second plane that is perpendicular to the first plane.

13. The roof tent of claim 12, wherein when the top frame is in the first position, the first plane is parallel to a plane comprising the top surface of the three-dimensional volume defined by the base frame.

14. The roof tent of claim 12, wherein when the top frame is in the second position, the first plane intersects the plane comprising the top surface of the three-dimensional volume defined by the base frame at an intersection angle between 20 and 30 degrees.

15. The roof tent of claim 2, when the top frame is in the first position, the roof tent is configured to be in a stowed configuration; and
when the top frame is in the second position, the roof tent is configured to be in an open configuration arranged to receive a user within the roof tent.

16. The roof tent of claim 15, wherein when the top frame is in the stowed configuration, the top frame and the base frame form a cage arrangement.

17. The roof tent of claim 3, wherein the fastening means are selected to be one of a hinge or clip.

18. The roof tent of claim 9, wherein the first portion has a base portion and a wall portion, wherein the base portion is connected to the base frame.

19. The roof tent of claim 18, wherein, when the top frame is in the second position, the wall portion extends from the base portion to the second portion and provides the walls of the opened roof tent; and
wherein when the top frame is in the first position, the wall portion is folded within the frame assembly.

20. The roof tent of claim 18, wherein the wall portion comprises an attachment means to attach the wall portion to the second portion.

21. The roof tent of claim 20, wherein the second portion comprises a complementary attachment means to engage with the attachment means of the wall portion and attach the wall portion to the second portion.

22. The roof tent of claim 9, wherein the second portion comprises skirt configured to overhang the top-frame such that when the top-frame is in the first position, the skirt overlaps the base portion.

23. The roof tent of claim 22, wherein the second portion comprises a tensioning means to tighten the skirt around the base portion.

24. The roof tent of claim 23, wherein the complementary attachment means is provided proximate to the top frame such that the skirt covers the attachment between the wall portion and the second portion in use.

25. The roof tent of claim 9, wherein the first portion is sandwiched between the base frame and the mounting means.

26. A kit of parts for a roof tent, the kit of parts comprising:
a mounting means for mounting the roof tent on a roof of a vehicle; and
a plurality of frame members configured to be reversibly connected to provide a frame assembly.
